(19) United States
(12) Patent Application Publication
(10) Pub. No.: US 2006/0069732 A1
(43) Pub. Date: Mar. 30, 2006

(54) Systems and Methods to Rank Electronic Messages and Detect Spammer Probe Accounts

(75) Inventors: Marvin Shannon, Pasadena, CA (US); Wesley Boudville, Perth (AU)

Correspondence Address: MARVIN SHANNON, 3579 EAST FOOTHILL BLVD, #328, PASADENA, CA, 91107, US

(73) Assignees: Marvin Shannon, Pasadena, CA (US); Wesley Boudville, Perth (AU)

(21) Appl. No.: 11/161,918

(22) Filed: Aug. 22, 2005

Related U.S. Application Data
(60) Provisional application No. 60/522,244, filed on Sep. 7, 2004.

(51) Int. Cl. G06F 15/16

(52) U.S. Cl. 709/206

(57) ABSTRACT

We show how to compute useful and robust metrics for a Bulk Message Envelope. These metrics are based on whether recipients of messages read them, and if so, whether they click on any links in those messages, or perform other allowed actions, and optionally the time order in which they perform these actions. We call these metrics a MessageRank, and show how these can be used by a message provider, like an ISP, to give more information to recipients, who can then form ad hoc groups (transient social networks) to assess a common BME and its sender. Users can also use their collective decision making to classify incoming messages. A message provider can offer these as value added services, to increase its attractiveness to its users, relative to other message providers that do not do so. We also show how to detect spammer probe accounts. These are used by spammers on large message providers, to craft messages that can pass through the providers' antispam filters. Our methods involve finding the earliest instances of messages in a Bulk Message Envelope that is spam. Or the earlier instance of a message pointing to a spammer domain. We show how spammers can respond to this, assuming best play on their part. In turn, we define user styles (heuristics) based on user click stream behavior, that can be used to isolate the probe accounts. Our methods can increase the spammers' manual effort and monetary cost.

This application claims the benefit of the filing date of U.S. Provisional application Ser. No. 60/522,244, “System and Method to Rank Electronic Messages”, filed Sep. 7, 2004, which is incorporated by reference in its entirety. It also incorporates by reference in its entirety the U.S. Provisional application Ser. No. 60/522,113, “System and Method to Detect Spammer Probe Accounts”, filed Aug. 17, 2004.

We show how to compute useful and robust metrics for a Bulk Message Envelope. These metrics are based on whether recipients of messages read them, and if so, whether they click on any links in those messages, or perform other allowed actions, and optionally the time order in which they perform these actions. We call these metrics a MessageRank, and show how these can be used by a message provider, like an ISP, to give more information to recipients, who can then form ad hoc groups (transient social networks) to assess a common BME and its sender. Users can also use their collective decision making to classify incoming messages. A message provider can offer these as value added services, to increase its attractiveness to its users, relative to other message providers that do not do so. We also show how to detect spammer probe accounts. These are used by spammers on large message providers, to craft messages that can pass through the providers' antispam filters. Our methods involve finding the earliest instances of messages in a Bulk Message Envelope that is spam. Or the earlier instance of a message pointing to a spammer domain. We show how spammers can respond to this, assuming best play on their part. In turn, we define user styles (heuristics) based on user click stream behavior, that can be used to isolate the probe accounts. Our methods can increase the spammers' manual effort and monetary cost.

### TECHNICAL FIELD

This invention relates generally to information delivery and management in a computer network. More particularly, the invention relates to techniques for automatically classifying electronic communications as bulk versus non-bulk and categorizing the same.

### BACKGROUND OF THE INVENTION

In several types of electronic communications, users are often confronted with unsolicited or unwanted bulk messages. When these messages are email, they are commonly known as spam. Similar phenomena have also been observed in Instant Messaging (IM) and Short Message Systems (SMS). Many methods have been used by Internet Service Providers (ISPs), and other message providers, to detect spam.

### SUMMARY OF THE INVENTION

The foregoing has outlined some of the more pertinent objects and features of the present invention. These objects and features should be construed to be merely illustrative of some of the more prominent features and applications of the invention. Other beneficial results can be achieved by using the disclosed invention in a different manner or changing the invention as will be described. Thus, other objects and a fuller understanding of the invention may be had by referring to the following detailed description of the Preferred Embodiment.

We show how to compute useful and robust metrics for a Bulk Message Envelope. These metrics are based on whether recipients of messages read them, and if so, whether they click on any links in those messages, or perform other allowed actions, and optionally the time order in which they perform these actions. We call these metrics a MessageRank, and show how these can be used by a message provider, like an ISP, to give more information to recipients, who can then form ad hoc groups (transient social networks) to assess a common BME and its sender. Users can also use their collective decision making to classify incoming messages. A message provider can offer these as value added services, to increase its attractiveness to its users, relative to other message providers that do not do so.

We also show how to detect spammer probe accounts. These are used by spammers on large message providers, to craft messages that can pass through the provider's antispam filters. Our methods involve finding the earliest instances of messages in a Bulk Message Envelope that is spam. Or the earlier instance of a message pointing to a spammer domain. We show how spammers can respond to this, assuming best play on their part. In turn, we define user styles (heuristics) based on user click stream behavior, that can be used to isolate the probe accounts. Our methods can increase the spammers' manual effort and monetary cost.

### DETAILED DESCRIPTION OF THE PREFERRED EMBODIMENT

What we claim as new and desire to secure by letters patent is set forth in the following claims.

In several types of electronic communications, users are often confronted with unsolicited or unwanted messages. When these messages are email, they are commonly known as spam. Similar phenomena have also been observed in Instant Messaging (IM) and Short Message Systems (SMS). Many methods have arisen to combat these, including those advocated by us in earlier U.S. Provisional filings: No. 60/320,046, “System and Method for the Classification of Electronic Communications”, filed Mar. 24, 2003; No. 60/481,745, “System and Method for the Algorithmic Categorization and Grouping of Electronic Communications, filed Dec. 5, 2003; No. 60/481,789, “System and Method for the Algorithmic Disposition of Electronic Communications”, filed Dec. 14, 2003; No. 60/481,899, “Systems and Method for Advanced Statistical Categorization of Electronic Communications”, filed Jan. 15, 2004; No. 60/521,014, “Systems and Method for the Correlations of Electronic Communications”, filed Feb. 5, 2004; No. 60/521,174, “System and Method for Finding and Using Styles in Electronic Communications”, filed Mar. 3, 2004; No. 60/521,622, “System and Method for Using a Domain Cloaking to Correlate the Various Domains Related to Electronic Messages”, filed Jun. 7, 2004; No. 60/521,698, “System and Method Relating to Dynamically Constructed Addresses in Electronic Messages”, filed Jun. 20, 2004; No. 60/521,942, “System and Method to Categorize Electronic Messages by Graphical Analysis”, filed Jul. 23, 2004. In the following text, we shall refer to these collectively as “Earlier” Provisionals.

Our methods in our previous filings can be optionally used in conjunction with the systems and methods disclosed here to modify the message ranking scheme.

In what follows, we specialize to the important case of email, to give substance to our methods. Our methods can be generalized to other electronic communications modalities (ECMs).

We assume for brevity that incoming messages are received by an Internet Service Provider (ISP) or a message provider. In general, our statements apply to any organization that runs a message server for its members. Also, when we say “user” below, we mean the recipient of a message.

The provider analyzes messages by our canonical steps in our Earlier Provisionals, to build Bulk Message Envelopes (BMEs). (Specifically, see the first Provisional, No. 60/320,046, with subsequent Provisionals expanding on this idea.) These contain various types of metadata, including domains, hashes, styles, users and relays. In essence, a BME attempts to undo most or all of any randomness deliberately introduced into a spam message, by its author. The spammer does this in order to send out many copies (millions perhaps) of that message, where each copy is unique, due to this randomness. This uniqueness helps the messages evade a simple antispam filter that records “signatures” of known spam, and then compares these against new incoming messages, to see if those are spam. Our Earlier Provisionals describe what we term “canonical” steps that are applied to a message, in order to reduce many sources of randomness, before making signatures (hashes) of the message.

A BME's users are the users who have received one or more copies of the BME's messages. In Earlier Provisionals, we described how we record for each user, the number of these copies received by that user. Here, we assume that we can record various extra data for a user:

Number of the BME's messages that the user has read.

Number of clickthroughs that the user has performed. [Assuming of course that the BME has selectable links.]

Number of users who have forwarded the BME's messages.

In the latter case, optional data found from analyzing the data streams.

Number of the BME's messages that the user deleted.

Any other allowable action in relation to the message type.

Time ordering of any subset of the above actions.

A message provider can trivially find whether a user has read a message or not. So item 1 above is straightforward to compute. If we are an ISP, then typically we are the physical means by which our users connect to a network like the Internet. Hence, we can analyze the data stream going from the user to the network and compute item 2. But suppose we are an email provider, whose users typically access us by using a browser. Since the users are already connected to the Internet, we may not be able to compute item 2 or 3. Though it is possible for us to modify the incoming messages before making them accessible to our users, by replacing any hyperlinks with hyperlinks that first go to our website, and thence to the URL in the original link. (Microsoft Corp.'s Hotmail does this, for example.) In this case, we can compute item 2.

Given the above information, there are mathematically an infinite number of ways to define how “popular” a BME is. We do not want to define it as a function of its number of messages, because this can be manipulated too easily by the sender simply sending out more such messages. As a simple measure of popularity, and as a preferred implementation, we define these quantities, and call them collectively the “MessageRank” of a BME:

Number or fraction of the BME's messages that have been read.

Number or fraction of the BME's read messages with selectable links chosen.

Note that here, these quantities might preferably be found across all of the BME's users.

Following our earlier remarks, we may not be able to compute item 2. Or if we can, we might not choose to do so, for whatever reason. In this event, the MessageRank would be just item 1. But in general, the MessageRank is a multidimensional quantity. It might also have more components, including but not limited to the following:

3. Number or fraction of the BME's messages that have not been deleted.

The fraction might be preferred over the number, since as mentioned above, this prevents a spammer from simply sending more copies of a BME, which might boost the number.

In the above, we can optionally have more complex weightings. For example, consider the first item, which is a measure of the number or fraction of a BME's messages that have been read. We can count each user that does so equally. Or, we can weight some users more than others. Say, if a user is in a list of top ranked reviewers (see below), we might weight that user as 2, compared to users not on the list, who get a weight of 1. Likewise, we might apply some weighting that is a function of the domains in the messages.

These quantities are robust against a sender attempting to artificially inflate them. It is possible for a sender to open accounts at the provider. Then she includes these accounts in her mailings of a BME, and then logs in and reads those BME messages. But this is manual and time consuming to do with many accounts. Also, if the accounts are not free, then there can be a substantial monetary cost.

The MessageRank components can be found algorithmically, as a simple extension of the methods in our Earlier Provisionals. Intuitively, each component is a measure of popularity, with the larger a value suggesting that more attention was given by users to that BME.

We draw an analogy between the MessageRank and various ranking systems for web pages. In the latter, the most effective ranking systems use the idea that a web page is higher ranked, the more that other web pages link to it. Our BME corresponds to a web page, and we can order BMEs by their MessageRanks. A key difference is that web pages are ranked due in large part to the actions and properties of other web pages. The former and latter are the same types of objects. In our case, the ranking is performed by users, which are of different type than the BMEs.

A similarity is that the ranking systems in both are algorithmic. It might be objected that in our case, the users' actions in reading or clicking are manual. But once a user does this, we algorithmically record the action. A user's manual actions correspond to the writing of a web page. But search engine spiders do not (and cannot) deal with a web page until it has been written and posted on the web, to end this analogy.

Given MessageRanks, the message provider can do various things. These include, but are not limited to, the following.

When a user, Jane, looks at a list of her messages, next to a message could be shown its MessageRank, or portions thereof. This gives her more information, to decide whether she should read it or not. Note that some senders use web beacons in their messages, to ascertain if their messages have been read. This works, assuming that providers don't block the downloading of such beacons when their users read the messages. Normally, neither a provider nor its users have any idea of the read response rate to a set of such messages, that form a BME. For each user, often she only knows for each of her own received messages, whether she has read these or not. And she does not know if a given message is the only message in its BME, or if it is in a BME with many messages. But by using our methods, the provider now can compute such information.

The provider could also compute an average MessageRank for a sender, based on the MessageRanks of its messages. Hence senders can also be ranked. In general, unless the sender's From address is known to be authentic, by whatever means, the sender should be considered to be a destination (base domain) found from links in the BMEs.

The provider may make MessageRanks available to users as a premium service. Plus, not all senders use web beacons. In part, because some providers block this, and may regard their existence as suggestive of spam. In any event, the provider could also make the data available to the senders, giving them more information about the efficacy of their mailings. It is assumed here that these senders are legitimate mailers, and do not forge their sender addresses.

Consider again when Jane looks at a list of her messages. Suppose she can click on a MessageRank. She may be able to see a list of the other users who have read it or picked a link inside the BME. There are privacy considerations here. So, for example, another user might have to consent before she appears in any such list. Or, the users in the list might have nicknames (“handles”), rather than their actual electronic addresses.

Jane may be able to contact those users, asking for their opinions on the message or BME in question, or to offer her opinion. A variant of this is to let her and others rate or classify the message. And when Jane clicked on the MessageRank, it might also show her an average rating derived from those, plus also the original ratings if she wishes to see more detail. Hence the MessageRanks can enable an easily understandable means of collaborative filtering.

Another variant is to connect the MessageRank to the ability to start a threaded newsgroup. There is well established open source software for the latter. So Jane and others might be able to easily start or join or review a discussion about a message or BME.

This gives a modicum of parity between sender and recipients. Typically, a sender has total control over whether its recipients know of each other. Our method lets the recipients of a BME find each other, without the sender's consent or knowledge. It should be emphasized that this can be done even, or especially if the (actual) sender forges the sender addresses on the BME's messages. Where the forging might be to the extent that each message has a different fake sender address. Typically, in such cases, the messages have links, and the actual sender or senders is the domain or domains at one or more of those links. But even if the messages in a BME have no links, the recipients can still by mutual consent, find each other.

Our method can also let users form ad hoc, transient communities (which may be considered to be “social networks”). Via joining a temporary newsgroup on a BME, for example. An advantage to the users is that they can get an idea of who shares a commonality of interests or hobbies. It also increases the stickiness of users as customers of the provider, versus other providers that do not make such information available.

Given that the provider can rank senders, it can make this list accessible to its users. Hence, users may be able to start, read or join a newsgroup concerning a sender, just as they could for a BME.

Another variant is the ability for Jane to have a list of favorite reviewers and a list of undesired reviewers. Here a reviewer is another user. So, for example, if Jane gets a message, and a BME copy of it is received by one or more of her favorites, then it is so indicated by the user interface (UI). If, say, Jane is reading her messages in a browser, then the UI is the web pages that her provider makes to display her messages. The UI could say how many of her favorites got a copy of it, perhaps. Likewise, the UI could indicate how many of her favorites read it, or clicked on a link inside it.

Conversely, Jane could tell the UI to indicate in a different fashion, messages whose BME copies were also received by people on her undesired list. Likewise, the UI could say how many on this list read it or clicked on a link inside it. Possibly, the UI might put all such messages in a different folder.

If a message had BME copies received by people on both lists, then the UI could indicate this in some fashion.

The provider could maintain a ranking of people on two lists. One list would show for each user on it, how many other users have her in their favorites lists. Another list could show for each user on it, how many other users have her in their undesired lists. Plus, a user might write some information about herself, like her hobbies or occupation. This information might be accessible from the two previous lists. It gives another user a means of deciding whether to add a user, e.g. Maurice, to her favorites or undesired lists—based on how many users have already put Maurice into their lists, and on what Maurice says about himself.

An advantage of such ranking lists is that a new user, who has never received any messages, can add people to her lists.

Also, the existence of these ranking lists and the favorite and undesired lists for each user makes it harder for a user to leave the provider.

Our methods can favor the largest message providers. Because these are more likely to be able to compute nonzero MessageRanks. Smaller providers might respond by peering with each other to increase the identification of MessageRanks. A message provider might sell its data as a regular, ongoing service, to other message providers, as an extra revenue source.

Similar Messages

Our previous discussions have been about exact matches of hashes, to put messages into a given BME. But it is possible for two BMEs to be similar. That is, if BMEs have n hashes each, that two BMEs are defined to be similar if they have at least m hashes in common, with m<n.

So consider Jane's messages. Next to a message could be shown, in some fashion, one or more of the following items:

The number of copies of messages in BMEs with n-1 hashes the same.

The number of copies of messages in BMEs with n-2 hashes the same.

[etc]

The number of users who have read BMEs with n-1 hashes the same.

The number of users who have read BMEs with n-2 hashes the same.

[etc]

The number of users who have clicked on links in BMEs with n-1 hashes the same.

The number of users who have clicked on links in BMEs with n-2 hashes the same.

[etc]

The number of users who have deleted BMEs with n-1 hashes the same.

The number of users who have deleted BMEs with n-2 hashes the same.

[etc]

In the above, the phrase “q hashes the same” [where q is “n-1” or “n-2”] is shorthand for referring to BMEs which have q hashes the same as q hashes in Jane's message. Also in the above, the term “number of” could be replaced by “fraction of”.

Likewise to the earlier discussion on using Jane's favorites and undesired lists, these could be used in a corresponding fashion here.

Detecting Probe Accounts

It has long been suspected that the largest ISPs or message providers have spammers who open accounts with them, and use these, not to send messages, but to receive messages sent by the spammers from outside the ISP. We call such accounts spammer probe accounts. Consider a spammer, Jane. Call her probe account Alpha, with its address being Alpha@isp.com. She uses this to craft a message that will pass through the ISP's antispam filters. From one of Jane's external accounts, she sends a message to Alpha. Then she sees if it arrived in Alpha's inbox, which is the ideal case. Or perhaps the ISP put it into Alpha's bulk folder, or rejected it outright, and hence never delivered it to Alpha. In the latter 2 cases, she might change the wording in the message and retry. She keeps doing this until presumably a final version of the message arrives in Alpha's inbox. Then Jane sends many copies of this to her mailing list of users at that ISP.

It is important to note that Alpha is a very low profile account. Many ISPs now have strictures against their users sending too many messages in a login session, or in some time interval. The intent is to deter those users from sending spam. By contrast, it is hard to distinguish Alpha from a typical user.

This problem is exacerbated by the probability that such probe accounts would tend to exist only on the largest ISPs or message providers. For two reasons. Firstly, those would have the bulk of the entries in Jane's mailing list, so it matters to her that her messages will get through to them. Plus, given the low response rate to most spam (typically now below 1%), it is an uneconomic use of her time to have such accounts on small ISPs. But the large ISPs or message providers typically have millions of accounts. Which makes it harder to distinguish Alpha from a typical user.

As a side note, companies or organizations that offer messaging services to their employees or members, but for which the messaging is not a primary business purpose, are unlikely to have probe accounts. [Though they may still get spam.] Typically, most companies have under 20,000 employees, say. Yet this size is probably around the lower end for an ISP to be economic. So it is not worth Jane's time to have an account with such a company. Plus, at least for corporate accounts, these are usually restricted to employees. Whereas ISPs or message providers essentially offer their services to anyone.

What is desirable is a method that is mostly or entirely algorithmic, that can find Alpha. Here, we offer such a system and method:

When the ISP decides that a BME is spam, by whatever means, then it looks for the user who got a first instance of it. And where there might be an “appreciable” time interval between this and when the bulk of the messages in the BME arrived. Presumably, this gives us the user Alpha. The duration of the time interval might be found empirically, or by logic external to this method.

Before we go further, we discuss a variant on this message crafting procedure that Jane might do. Suppose she knows that the ISP applies a blacklist against domains found in links in the bodies of messages. Suppose also that she has a domain, beta.com, that she plans to write spam messages for, that will contain links to it. She might want to test whether the ISP already has beta.com in its blacklist. So she sends Alpha a message with a link to beta.com. If it gets to Alpha's inbox, then she might be confident that it is not in the blacklist. Then she might send spam about beta.com to her mailing list. This could be different from the above use of Alpha, inasmuch as the spam messages might have totally different text than the first message to Alpha. But in this case, if the ISP later decides that beta.com is a spammer domain, by whatever means, then it can look for the BMEs pointing to it. And then look for the BME with the earliest message. This should reveal Alpha.

As an aside, we might ask why Jane needs to test beta.com against the blacklist? Suppose beta.com is a brand new domain name that Jane has registered. It has never been used before. Surely there is no chance that it is in any blacklist? Probably but not necessarily true. Beta.com is presumably a functioning web site. So it maps to an IP address. These addresses can get reused, to be reassigned to different domains, for various reasons. Jane cannot be absolutely sure that her IP address was not earlier used by another spammer. And a blacklist might include both a domain name and its IP address. So the ISP's blacklist might contain her IP address. Also, a variant on the blacklist usage is for the ISP to block some neighborhood of the addresses. So if close addresses are or recently were used by spammers, Jane might get hers blocked because of this. So if Jane is careful, she may want to test the blacklist.

It turns out that Jane has a countermeasure against Alpha being the first recipient of a message. Suppose her list of the ISP's users has n entries. She might pick a small subset, rho, with m users, where m<<n. Then, when crafting a message or testing if beta.com is in the blacklist, she sends it to Alpha+rho. She hides Alpha amongst the rho users. Quite possibly, she will ensure that the first recipient is not Alpha.

The first issue for the ISP is, how big is m? Imagine n˜million. For the largest ISPs and message providers, they may have tens of millions of accounts [or more]. In this case, the estimate for n is quite realistic. What if Jane decides to pick 0.1%˜1000 users for rho? But remember, Jane does not know all the criteria by which the ISP decides that a BME is spam, or that a domain is a spammer domain. Jane runs the risk that if rho is too big, the ISP might consider these early messages as spam, and thence block any future messages with those hashes, or add any contained domains into its RBL. Ironic. So this puts some upper bound on rho. Realistically, if the ISP uses the methods in our Earlier Provisionals, possibly in conjunction with other methods, and becomes very adept at detecting bulk messages, then rho might have to be on the order of 10 users or so.

Define an “active user” in some time interval [t0, t1] as a user who logs in during this interval OR (is already logged in before t0 AND asks the ISP for an update of her messages during the interval).

In general, amongst the rho users, Jane will not know who is currently logged in. So, after the fact, the ISP can search amongst Alpha+rho for users who were active when those messages came in. This will help reduce the list of possible probes.

A complication arises with some message providers that have a feature that when you log in, you may be able to see which other users are currently logged in, out of a list of your contacts with accounts on that message provider. This may be implemented under the rubric of social networking, or building user communities. But for whatever reason that it was done, Jane now has an alternative. Prior to sending any messages, she might have made another probe account, Kappa. Into this, she puts a large list of users, drawn from her mailing list. Then, just before she starts sending messages to Alpha, she logs into Kappa. She sees who is currently logged in amongst Kappa's list, and she derives rho from it. Then she sends her test message to Alpha+rho.

But even here, some fraction of rho's users will logout before getting the test messages from Jane. And another fraction will be logged in, but inactive. So we can still cull rho.

The ISP can attempt to detect Kappa. It keeps a record of when each user logs in. So when Kappa asks it for who amongst a list of users that Kappa is interested in, is logged in, it can record that Kappa got a reply with a list of currently logged in users. There are several ways it can try to isolated Kappa as a probe account. One such way is the following. When later, it finds Alpha+rho, it makes a hash table. The key is a user. The value is the number of users in Alpha+rho that the user has received information from the ISP about, saying that each users is currently logged in. Obviously, there would have to be some cutoff in time, before the first instance of a message. This cutoff does not need to be too long in duration, because Jane must act quickly upon getting information about who is currently logged in, before it becomes outdated.

Given this hash table, by finding the keys with the largest values, the ISP can narrow down the possibilities for Kappa. This method can handle the case where Jane uses several Kappas, for example. Plus also if Jane puts into rho, users that were not returned to Kappa by the ISP. These extra users would be distractors. Plus also if Jane omits from rho some currently logged in users returned to Kappa from the ISP. These effect of these obfuscation techniques by her can be minimized by the ISP.

In the process of crafting a message, suppose Jane needs to send several versions of a message, before finding one that passes the filters. For 2 tries, we have this sequence of events:

Jane sends a message to Alpha+rho.

She logs into Alpha and sees that it did not get into the inbox. She might log out or stay logged in.

She sends a second message to Alpha+rho.

If she had logged out earlier, she needs to log in. Else she does an update.

From this, it can be seen that we can cull users from rho who were not active between when the first message was received and when the second message was received. Plus, we can also remove users who were not active between when the second message was received and when the bulk of the messages were received. Clearly, the more times Jane has to craft a message, the easier it is to reduce rho.

Jane has a countermeasure. The above assumes that Alpha+rho is constant over all iterations. Suppose she varies rho between iterations. Then we pick Alpha trivially, because Alpha remains constant. Or she holds rho constant, and uses a different Alpha in each iteration. Likewise, we pick all these Alphas. So to avoid this, she can use a different Alpha and rho in each iteration. This necessitates a lot more work, that is hard to automate. Jane needs to set up many accounts beforehand. And for picking each rho, if she wants it confined to logged in users, for maximum camouflage, she has to do more work, possibly with a different Kappa account for each iteration.

Plus, if the ISP or message provider does not offer free accounts, then her monetary costs also rise to open the probe accounts.

Suppose Jane does this. Her strongest strategy; though with the above costs. Now the ISP can only count on one iteration using Alpha+rho. We now define a set of heuristics that the ISP can compute for a user. We call these styles. They differ from those in our earlier filings, inasmuch as those tended to be derived from the canonical steps in forming a BME. That is, those styles were associated with messages. The styles below are essentially derived from the user's click stream behavior. Hence, we are applying information across different ECM spaces.

Define these styles:

Does the user login from a known anonymizer? The ISP can maintain a list of the major anonymizers, in order to make this comparison.

Does the user login from an IP address in the blacklist? Assuming, of course, that a blacklist is being used.

Does the user login from an IP address in the neighborhood of an address in the blacklist? Here, neighborhood can be defined by various means.

Does the user forward messages? One way for Jane to avoid logging into Alpha is to set up Alpha to forward messages. If she is using a free email account, then this is often not possible. Such free email providers may offer forwarding only for paid accounts, as an inducement for users to migrate to these. So forwarding may often have a monetary cost to Jane.

Does the user login from a domain in the BME under investigation?

Does the user login from an IP address in the neighborhood of a domain in the BME under investigation?

Was the user active between when she got the message and when the bulk of the BME's messages arrived?

Does the user send no messages, between when she got the message and when the bulk of the BME's messages arrived? We are using this as a measure of lack of activity that a user performs with her account. Here, this time interval can be replaced by some other interval. An ISP might already have some counter that measures how many messages a user sends in some time interval. Used to detect an account that might be sending spam, as discussed earlier. We can use this counter here, checking for a lower bound.

We emphasize that the above list can be expanded; other styles may also be defined. The styles shown above have the common property that an answer in the affirmative for any is a suggestive sign of a probe account. And the more positive answers that there are, the greater the likelihood that the account is indeed a probe account.

From a practical viewpoint, finding the above styles can be done computationally. No manual effort is involved. Though it is possible that after these are found, and applied to reduce the size of Alpha+rho, that the latter is subject to manual scrutiny. But perhaps even not. If we reduce Alpha+rho down to several (>1) users, we might wish to take no further action. Because we have forced Jane to institute the above countermeasures that have raised her cost structure.

There is another consideration. Jane cannot be sure that the ISP has not, in fact, been able to reduce Alpha+rho down to just Alpha. While rho may perhaps have been derived from information that Jane got about currently logged in users, once she sends the messages, it is possible that the users in rho might log out or never update. So that rho can be eliminated. Or through the use of the above styles, the ISP can discard all the users in rho. So best play by her is to assume that Alpha will be found by the ISP.

In Provisional 60/320,046, we have discussed what might be done, once we have isolated a probe account. For example, the ISP might place a flag on Alpha, so that future usage will alert a system administrator, who can then manually and in real time see what Alpha is doing, and hence block future spam being crafted using it.

A utility of our method is that we increase the cost to the spammer, in terms of money and time. For the latter, we anticipate that much of the spammer's effort will be manual; difficult to automate. Whereas, most if not all of our methods can be automated. Hence, we push the burden onto the spammer.

A potentially useful application of our method involves attacking phishing. This is a type of spam that is fraudulent. It is characterized by the phisher sending many messages, typically purporting to be from a financial institution or large company, at which the recipient has an account. Often, the message will claim that the recipient needs to re-enter certain crucial pieces of information, like her account number or username, and her password. The message usually visually looks like it came from the purported source. It may have images downloaded from the latter, to reinforce this impression. But it may have, and this is the point of the message, a link or button that is actually to a different location. So if the user fills out her personal data in the message and presses the button, the information is sent to the phisher. Or if the user follows the link, she gets to a page where she is encouraged to fill out information, and this page is then sent to the phisher.

Phishing messages tend to be very carefully crafted. Both in the wording and in any visuals. Unlike a typical spam message, phishing is considered highly damaging, because it involves actual fraud. There is incentive for an ISP for prevent it. A phisher may want or need to craft her message, before sending out many copies of it. Suppose she uses the approach that Jane used, to have a probe account, Alpha, and hide it amongst a set of other users, rho. She may be effectively constrained in the size of rho, or indeed even using rho at all. If one of these users reads an early message attempt, she could inform the ISP or the actual company the phisher is mimicking. But without rho, the ISP can find Alpha.

What is claimed is:

1. A method of recording for a Bulk Message Envelope (BME) various data, including one or more of the following: the number or fraction of users (recipients) who have read the messages; the number or fraction of clickthroughs (i.e. selectable links being chosen in the messages); the number or fraction of messages that have not been deleted by the users. We term these quantities to be the MessageRank of a BME.

2. A method of using claim 1 to display to a user, her messages, with MessageRank data, or subsets thereof, or functions of the MessageRank data, next to one or more of her messages.

3. A method of using claim 2 to let the user sort or classify or delete or retain a subset or subsets of her messages, based on their MessageRanks.

4. A method of using claim 1, to take MessageRank data and apply these to help classify any domains within the BMEs, possibly as spam domains.

5. A method of an ISP finding for a BME that has been deemed to be spam, the user who got the earliest message in the BME, and then classifying that user as a possible spammer probe account.

6. A method of using claim 5, but taking some number of the earliest recipients of a BME's messages, and classifying these as possible spammer probe accounts.
